(19) United States
(12) Patent Application Publication
(10) Pub. No.: US 2026/0127129 A1
(43) Pub. Date: May 7, 2026

(54) TECHNIQUES FOR COUPLING PERIPHERAL DEVICES IN LOW-AND ZERO-TRUST ENVIRONMENTS

(71) Applicant: Absolute Software Corporation, Vancouver (CA)

(72) Inventors: Sherman Chingman LOK, Surrey (CA); Jason XUN, Burnaby (CA); Dino Marco Wong YAO, Richmond (CA); Michael Soon Lee GOH, Vancouver (CA)

(21) Appl. No.: 18/934,520

(22) Filed: Nov. 1, 2024

(51) Int. Cl. G06F 13/40

(52) U.S. Cl. CPC G06F 13/4068; G06F 2213/40

(57) ABSTRACT

Disclosed herein are methods for coupling a peripheral device to a client device. The methods include computing usage data for peripheral devices coupled to a fleet of client devices; adding peripheral devices from the peripheral devices coupled to the fleet whose usage data meets a threshold to a whitelist; detecting an attempt to connect a new peripheral device to an individual client device; determining acceptability of the new peripheral device based on its presence on the whitelist, and, in response to the determining: coupling the new peripheral device on the individual client device if the new peripheral is on the whitelist; or preventing the coupling of the new peripheral device on the individual client device if the new peripheral device is not on the whitelist. Methods and systems and for operating low-trust computing environments with acceptable peripheral devices are also disclosed.

### FIELD OF THE INVENTION

This application relates to the coupling of peripheral devices to client devices. In particular, the application relates to the determination of the acceptability of coupled peripheral devices to a primary computer system.

### BACKGROUND OF THE INVENTION

Modern computer devices may have different types of peripheral devices coupled to them. The peripheral devices include printers, scanners, human interface devices (such as keyboards, mice, touchpads, joysticks, gamepads, speakers, headsets, displays, virtual-and augmented-reality devices, etc.), removable storage (such as external hard drives and flash drives), external optical drives, webcams, media card readers, and others. When coupling these devices to a computing device, many peripherals require the installation of software on the computing device, such as device drivers, to enable them to work with the computing device.

However, the process of installing of drivers for peripheral devices creates a potential point of vulnerability, for example, if drivers are compromised or other exploits are present, that a malicious actor could exploit (such as seeking to gain administrator-level access). In one scenario, a malicious actor may attempt to exploit a local privilege escalation vulnerability when plugging in a mouse to a computing device running a particular operating system (e.g., the Microsoft Windows™ operating system, Linux operating systems, etc.). These vulnerabilities allow the malicious actor to gain administrator-level privileges by taking advantage of the fact that some peripheral devices (e.g., universal serial bus (USB) devices) automatically load software upon connection to a primary computer system, and that software installation happens with elevated privileges.

One approach to address the security vulnerabilities would be to employ a low-or zero-trust security model, where an organization's technological systems are secured based on the idea that no device or person should be trusted by default, even if they are already inside an organization's network. In this approach, every request to access resources (such as the use of a new peripheral device being connected to a computing device) would be treated as if it comes from an untrusted source until it has been inspected, authenticated, and verified. However, potentially significant resources would need to be devoted to the manual inspection, authentication and verification of requests.

There exists a need for improved or alternative methods for coupling peripheral devices to computing devices.

### SUMMARY OF THE INVENTION

In an aspect, there is provided a method for coupling a peripheral device to a client device, the method. The method includes computing, at a server, usage data for peripheral devices coupled to a fleet of client devices. Peripheral devices from the peripheral devices coupled to the fleet whose usage data meets a threshold are added to a whitelist. Upon detection of an attempt to connect a new peripheral device to an individual client device, the acceptability of the new peripheral device is determined based on its presence on the whitelist. In response to the determining, the new peripheral device is coupled to the individual client device if the new peripheral is on the whitelist; or prevented from being coupled to the individual client device if the new peripheral device is not on the whitelist.

In some embodiments, the preventing and installing of coupling for the new peripheral device includes detecting processes being executed on the individual client drive during the attempted connection of the new peripheral device.

In some embodiments, the detecting includes identifying one or more processes executed based on instructions provided by the new peripheral device.

In some embodiments, the new peripheral device is an input device, an output device, or an input/output device. In some embodiments, the new peripheral device is a removable memory storage device.

In some embodiments, the attempt to connect the new peripheral device is via a wireless or a wired interface. In some embodiments, the wired interface is universal serial bus (USB), high-definition multimedia interface (HDMI), display port (DP), peripheral component interconnect express (PCIe), serial AT attachment (SATA).

In another aspect, there is provided a method for operating a low trust user device environment. The method includes detecting a connection of a peripheral device to a client device. The acceptability of the peripheral device is determined based on acceptance criteria from a device management server. In response to the determining, the peripheral device is coupled to the client device; or prevented from being coupled to the client device.

In some embodiments, the acceptance criteria include a whitelist.

In some embodiments, the detecting includes receiving a hardware identifier from the peripheral. In some embodiments, the hardware identifier includes a vendor identifier and a device identifier.

In some embodiments, the method includes sending an alert to the device management server of the connection of the peripheral. In some embodiments, the device management server updates the acceptance criteria based on the alert.

In some embodiments, the device management server updates the acceptance criteria based on usage data received from a fleet of user devices, the usage data including information about peripheral devices connected to the fleet.

In some embodiments, the determining includes verifying the integrity of a driver for the peripheral device prior to coupling. In some embodiments, the verifying the integrity includes comparing checksum of the driver.

In some embodiments, the determining is based on local acceptance criteria and wherein the method further includes receiving the acceptance criteria from the device management server and updating the local acceptance criteria based on the received acceptance criteria from the device management server.

In some embodiments, the device management server is configured to send updates of the acceptance criteria to a fleet of client devices.

In some embodiments, the method includes monitoring of processes executed on the user device prior to the coupling of the peripheral device, during the coupling of the peripheral device, or both.

In another aspect, there is provided a system for operating a low trust computing environment. The system includes a peripheral device, a client device, and a device management server. The client device is configured to detect a connection of the peripheral device to the client device, determine acceptability of the peripheral based on acceptance criteria; and, in response to the determination, couple the peripheral device to the client device; or prevent the coupling of the peripheral device to the client device. The device management server is configured to provide the acceptance criteria to the client device.

In some embodiments, the client device is part of a fleet of client devices configured to send usage data to the device management server, the usage data including information on peripheral devices connected the fleet.

In some embodiments, the device management server updates the acceptance criteria based on the usage data received from the fleet.

In some embodiments, the client device receives a hardware identifier from the peripheral upon the detection of the connection. In some embodiments, the hardware identifier includes a vendor identifier and a device identifier.

In some embodiments, the client device sends an alert to the device management server of the connection of the peripheral.

In some embodiments, the device management server is configured to update the acceptance criteria based on the alert.

In some embodiments, the coupling includes installing, on the client device, a driver for the peripheral device.

In some embodiments, the installing includes verifying the integrity of the driver prior to installation.

In some embodiments, the determining is based on local acceptance criteria and wherein the method further includes receiving the acceptance criteria from the device management server and updating the local acceptance criteria based on the received acceptance criteria from the device management server.

In some embodiments, the usage data includes information processes running on the client device prior to the installing of the peripheral device, during the installing of the peripheral device, or both.

### BRIEF DESCRIPTION OF THE DRAWINGS

The features of the invention will become more apparent in the following detailed description in which reference is made to the appended drawings wherein:

FIG. 1 is an illustration of an environment in which the present disclosure may be deployed in accordance with some embodiments of the invention;

FIG. 2 is a flow diagram illustrating a method for coupling a peripheral device to a client device according to an embodiment;

FIG. 3 is a flow diagram illustrating a method of operating a low trust user device environment according to an embodiment; and

FIG. 4 is an illustration of a system according to an embodiment of the invention.

### DETAILED DESCRIPTION OF THE INVENTION

In the following detailed description, numerous embodiments and details are described to provide a thorough understanding of the invention. However, these embodiments may be modified and details omitted without necessarily departing from the scope of the invention herein. In other instances, well-known methods, procedures, components and systems have not been described in detail so as not to obscure the presently disclosed subject matter.

As used herein, the phrases “for example,”, “e.g. ”, “such as”, “for instance”, “including”, and “comprising” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

Unless specifically stated otherwise, features described in separate embodiments can be combined into a single embodiment. Conversely, features described in the context of a single embodiment can be provided separately or in any suitable sub-combination in other embodiments.

As used herein, the term “connection” means a communication link established between two devices, such as between a peripheral device and a computing device, or between a computing device and a server. A connection may be a physical connection, such as when a peripheral device is physically plugged into a computing device, such as by a cable. Various standards exist for physically connecting peripheral devices, including universal serial bus (USB), PS/2, parallel port, serial port, IEEE 1394 (e.g. FireWire or i.LINK), small computer system interface (SCSI), high-definition multimedia interface (HDMI), display port (DP), peripheral component interconnect express (PCIe), serial AT attachment (SATA). Devices may also be connected wirelessly, including through the standards Bluetooth, Z-Wave, Zigbee, and IEEE 802.11x (Wi-Fi or WLAN). A peripheral device that is connected directly to a client device is considered locally connected. In contrast, where there is an additional interface device or network device relays information between the client device and the peripheral device, they are remotely connected.

As used herein, the term “coupled” in the context of a peripheral device refers to peripheral devices that are both connected (e.g., physically or wirelessly) to a computing device and can be used as intended with the computing device (e.g. where a device driver for the peripheral device is installed on the computing device).

As used herein, a “client device”, “computer system” or a “computing device” may be used interchangeably, and refers to any general-purpose computing device capable of use with a peripheral device. Examples of client devices include computers, servers, workstations, thin-clients, mobile computers, mobile phones, and tablet computers.

In low-trust environments, peripheral devices must be approved for use with client devices before they can be coupled. However, to individually approve each peripheral device may be tedious and be taxing on resources. This is especially true where the same peripheral device is ordered in bulk for a number of client devices, as approving each device for use with a client device would be repetitive. Accordingly, it is desirable to be able to maintain security in a low-trust environments when coupling peripheral devices without having to manually approve peripheral devices.

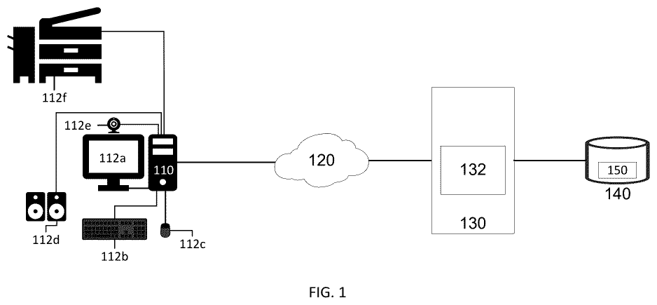

FIG. 1 illustrates an example of an environment 100 in which a whitelist of peripheral devices can be generated from a number of different client devices can be determined, according to some embodiments. The example environment 100 can include one or more client devices 110.

Each client device 110 may be connected to one or more peripheral devices 112 (depicted as a display 112a, keyboard 112b, mouse 112c, speakers 112d, webcam 112e and printer 112f).

Each client device 110 is configured to communicate with a server 130, such via a network 120. Server 130 includes a peripheral usage monitor 132 that is configured to transmit and receive data related to data usage. In some embodiments, peripheral usage monitor 132 is a module executed from computer memory that resides on server 130 using one or more processors. In one scenario, client devices 110 may be configured to communicate data about its operation (e.g., usage data) to peripheral usage monitor 132. In some embodiments, usage data includes a list of the peripheral devices 112 coupled thereto, the vendor ID and model ID of the coupled peripheral device 112, application usage and other types of computer processes executed on the device 110.

The peripheral usage monitor 132 communicates with a data store 140 having a whitelist 150 stored thereon, or, when there is no whitelist 150 stored by data store 140, creates one. The data store 140 may be part of server 130 or remote therefrom. In some embodiments, the whitelist 150 may be accessed by the client device 110 or be downloaded to a memory thereon, such as a hard drive, random access memory, flash drive, or similar.

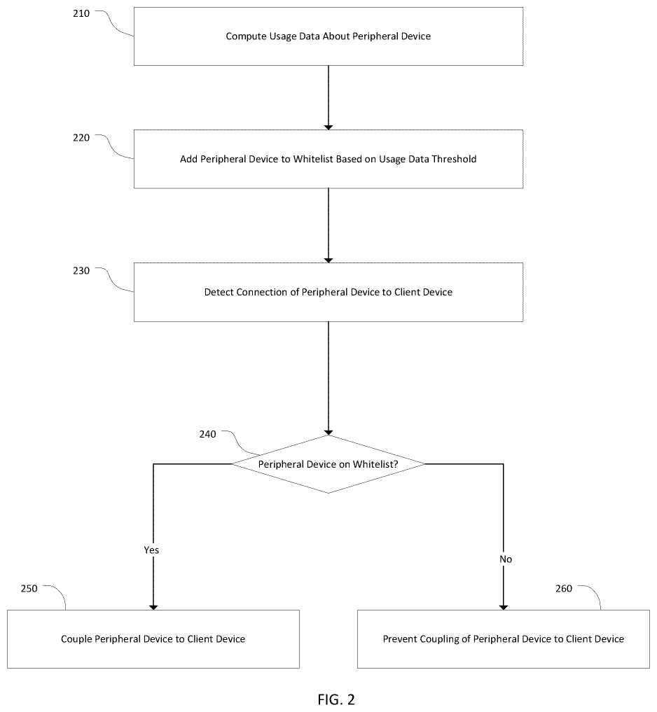

With reference now to FIG. 2, there is provided according to an aspect, a method 200 for coupling a peripheral device to a client device. At block 210, a peripheral usage monitor 132 computes the usage data from a number of different client devices about the peripheral devices coupled thereto. In some embodiments, the peripheral usage monitor is run on a server remote from the client device. In other embodiments, the peripheral usage monitor is run locally on the client device.

In some embodiments, peripheral devices transmit peripheral device information to client devices upon establishing a local connection between them. The peripheral device information can include, for example, a vendor ID, a product ID, or a combination thereof. The vendor ID identifies the vendor or manufacturer of the peripheral device. In one embodiment, the product or device ID identifies the particular type or model of the device, such as a particular model of keyboard, or webcam, manufactured by a particular company. In some cases, it can also include the version or revision of the device. In some embodiments, the vendor ID, product ID or both may be provided as hexadecimal values. For example, Microsoft may be identified as vendor “045E” and the Surface keyboard identified as product ID “07CD”; and Logitech may be identified as vendor “046D” and the C902 Pro HD webcam identified as product “08E5”.

One or more computing devices can be configured to transmit peripheral device information of peripheral devices connected thereto to the peripheral usage monitor. In some embodiments, peripheral device information is sent from the different client devices using software products from a particular company (e.g., Absolute Software Corporation).

At block 220, peripheral devices coupled to the number of client devices whose total usage data for the peripheral devices meets predetermined criteria (e.g. a threshold value) are added to a whitelist. For example, the threshold value may be based on the total number of peripheral devices having the same peripheral device information that are connected to client devices. The predetermined criteria, whitelist or both can be stored in memory resident on server 130. The whitelist includes peripheral devices that may be coupled to client devices without having to obtain approval from an administrator. The whitelist may be generated or modified by the server.

Where a whitelist did not previously exist, it can be generated by the server based on the usage data. However, the fact that a peripheral device was used with a client device may be insufficient for inclusion on a whitelist. For example, before the implementation of a low-trust computing environment, peripheral devices may not have needed approval prior to coupling with a client device or system. Users may have unapproved peripheral devices coupled to their computing device. In such an environment, when a first implementing low-trust computing environment in which peripheral devices cannot be coupled to client devices without authorization, the whitelist would not have existed. Further, even where a peripheral device is approved, coupled peripheral devices may been approved on a case-by-case basis, as a legacy device, and/or as a trial device. Accordingly, in some embodiments, the predetermined criteria (e.g. threshold values) can be used to differentiate peripheral devices for use on client devices that have been approved on a case-by-case basis, legacy peripheral devices, and/or as a trial, from those peripheral devices that have been approved for fleet-wide deployment.

In some embodiments, the threshold values are based on the usage data indicating that the same model of a peripheral device is coupled to a particular percentage of a fleet of client devices (i.e., anywhere between 1 and 100%). In other embodiments, the threshold is based on the usage data indicating that a threshold number of the same model of the peripheral device is coupled to the fleet.

In other embodiments, where a whitelist previously existed, the whitelist can be updated based on the usage data. In this fashion, peripheral usage monitor 132 can be configured to observe peripheral usage trends within a specific computing environment that includes a particular set of client devices and dynamically add those peripheral devices to a whitelist. The procedures performed by peripheral usage monitor 132 to observe and process trend data to construct or add to a whitelist in this manner can be separate from a computer network importing a listing of devices deemed “safe” from a third-party organization or a network administrator put in charge of protecting the computing environment.

At block 230, there is a detection of when an attempt to connect a new peripheral device to a client device is made. This can occur, for example, when a human interface device or removable storage device is physically or wirelessly connected to the client device of the fleet. In some embodiments, the detection occurs at the client device, the server, or both. For example, once the connection attempt is made, the new peripheral device transmits its peripheral device information to the client device where it is detected by the client device. In some embodiments, the peripheral device information is transmitted to the serve, such as through a network connection between the client device and the server, where it is detected by the server.

Once an attempt to connect the new peripheral device is detected, there is a determination at block 240 of whether the new peripheral device is acceptable for coupling to the client device based on whether it is on the whitelist, such as by the peripheral usage monitor. In some embodiments, the detection occurs at the client device, the server, or both. For example, the determination may be made at the client device based on a local whitelist or on a whitelist stored remotely. Alternatively, the determination is made at the server based on a whitelist stored on a datastore available to it based on peripheral device information transmitted to it via the client device, and a decision is sent back to the client device.

If the new peripheral device is not on the whitelist, the new peripheral device is prevented from being coupled to the client device at block 250 by the device making the determination at block 240. For example, drivers for the new peripheral device may not be permitted to be installed or prevented from being installed on the client device. Alternatively or additionally, the client device terminates the connection with the peripheral device. For example, where the peripheral device is physically connected to the client device, the client device may refuse, ignore or terminate communication attempts by the peripheral device.

If, instead, the new peripheral device is on the whitelist, the new peripheral device is permitted to be coupled to the client device at block 260. For example, a driver for the new peripheral device is permitted to be installed, such as through access of generic drivers provided by the operating system or by retrieving and installing the drivers from a host device. In some embodiments, the new peripheral device is programmed to automatically retrieve the drivers from the host device upon receiving permission for coupling.

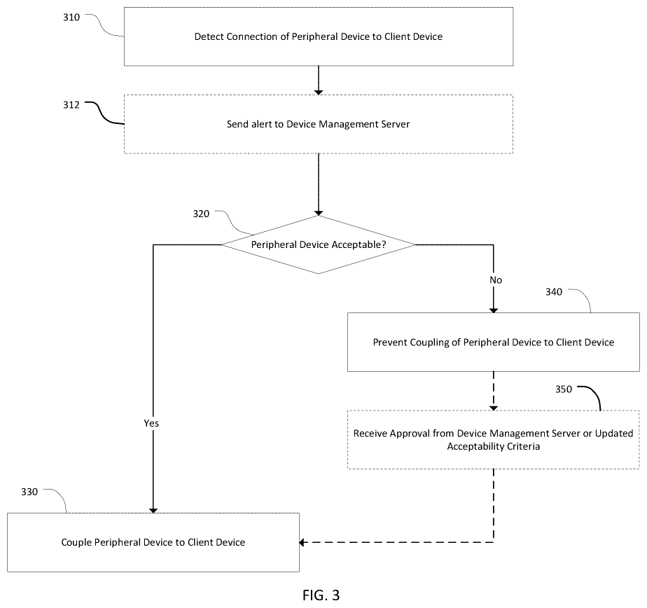

Having reference to FIG. 3, a method for operating a trusted user device environment 300 according to another aspect of the invention is disclosed. At block 310, a connection of a peripheral device to a client device is detected. By the connection, peripheral device information, is transmitted from the peripheral device and received by the client device. In some embodiments, the peripheral device information includes a hardware identifier. In some embodiments, the hardware identifier includes a vendor identifier and a device identifier. In some embodiments, the peripheral device information is transmitted by the client device to a peripheral usage monitor. In some embodiments, the peripheral usage monitor is on a server, the client device, or both.

At block 320, the acceptability of the peripheral device is determined based on acceptance criteria from a server (e.g., a device management server). In some embodiments, the peripheral device transmits the peripheral device information to the device management server via the client device, where device management server (e.g., a peripheral usage monitor module thereof) performs the determination and the result is transmitted back to the client device. In some embodiments, the acceptance criteria are stored on the server, a data store accessible to the server, or both. In other embodiments, the client device performs the determination using a local copy of the acceptance criteria stored thereon. In some embodiments, the local copy is a persistent copy of the acceptance criteria. In other embodiments, the local copy is a transient copy, such as one that is retrieved from the device management server by the client device in response to the detection of the peripheral device. In some of these embodiments, the local copy of the acceptance criteria stored on the client device is updated, for example periodically or in response to the detection of the peripheral device, with updated acceptance criteria received from the device management server. In some embodiments, the device management server is configured to send updates of the acceptance criteria to a fleet of client devices.

If, at block 320, it is determined that the peripheral device is acceptable for coupling to the client device, the peripheral device is permitted to be coupled to the client device at block 330. Otherwise, the peripheral device is not permitted to be coupled to the client device at block 340.

In some embodiments, the acceptance criteria include a whitelist, where only peripheral devices on the whitelist are permitted to be installed; a blacklist, where peripheral devices on the blacklist are not permitted to be installed; or both. In low-to zero-trust environments, a whitelist helps to ensure that only peripheral devices that have been approved can be installed. In higher-trust environments, a blacklist may be used to prevent the installation of known problematic peripherals. In a relatively complex environment that has been operating for a long time and/or having a myriad of peripheral devices, a blacklist may be a relatively smaller file that is more easily transmitted to client devices.

In some embodiments, the method optionally includes receiving an alert at the device management server of the connection of the peripheral device to the client device at block 312. In some embodiments, an alert is generated by the peripheral usage monitor. In response to the alert, a user may optionally receive a reminder on the client device of the computer usage policies within the trusted user environment or additional training on the computer usage policies within the trusted user environment. The type of response may depend on the number and/or frequency of the alerts received by the device management server, the peripheral devices attempted to be coupled (e.g. if it is one device that the user tried to couple multiple times in a single session, or multiple different devices being unsuccessfully coupled over multiple sessions).

In some embodiments, an approval may be received from the device management server following an alert that is to couple the devices. In some embodiments, where a peripheral device is initially prevented from being coupled, the client device may subsequently couple the peripheral device in response to the alert. For example, in some embodiments, an administrator overlooking the device management server may view the alert and communicate with the user to determine whether the peripheral device should be approved, such as for the fleet of devices, as an exception, or as part of a trial for a number of devices. The administrator may override the prevention of the coupling. For example, the administrator may use administrator privileges to couple the peripheral device, update the acceptance criteria, or both at block 350. Alternatively, the administrator may specify additional follow-up actions, such as mandated technology usage policy training.

In some embodiments, the acceptance criteria are generated based on usage data received from the fleet of client devices, including data on the peripheral devices connected to the client devices. As noted above, this may, for example, be based on a threshold number of devices coupled to client devices of the fleet.

In some embodiments, the coupling comprises verifying the integrity of a driver of a peripheral device prior to its coupling to the client device. For example, a checksum of the driver may be used to determine whether a driver has been misdelivered, altered, corrupted, or otherwise modified during delivery.

In some embodiments, processes executed on the client device prior to or during the connection, prior to or during coupling of the peripheral device, or a combination thereof, are monitored. This may, for example, be used to prevent malicious code from being executed by the client device, such as the installation of root kits, or exploits of local privilege escalation vulnerabilities during driver installation.

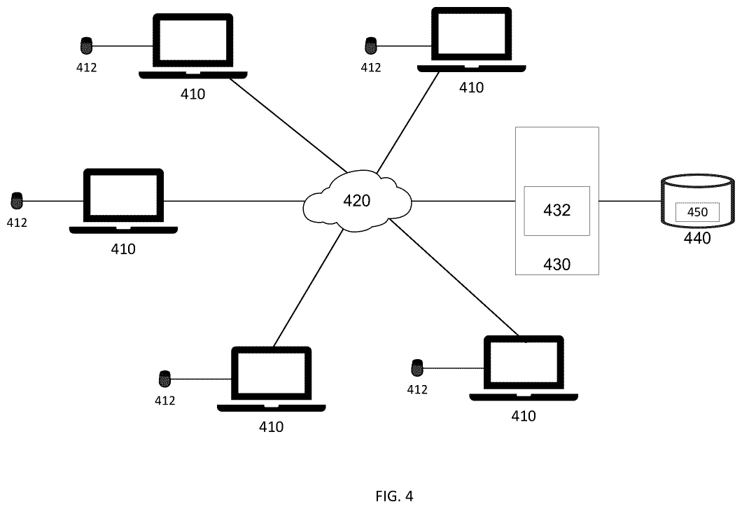

Turning now to FIG. 4, a system 400 for operating a low trust computing environment is illustrated. The system includes a peripheral device 412, a client device 410 and a device management server 430. The client device 410 is configured to detect a connection of the peripheral device 412, determine the acceptability of the peripheral device based on acceptance criteria, and, in response to the determination, couple the peripheral device to the client device or prevent the coupling of the peripheral device to the client device. In some embodiments, the acceptability criteria include a whitelist 450. In some embodiments, the whitelist 450 may be stored on a data store 440. In some embodiments, the whitelist 450 may be transmitted to a client device 410.

In some embodiments, the system 400 includes a fleet of client devices 410. Each client device 410 of the fleet sends usage data to the device management server 430, the usage data including information about the peripheral devices connected thereto. In some embodiments, the device management server 430 (or a peripheral usage monitor 432 run thereon) updates the acceptance criteria based on the usage data. In some embodiments, the updated acceptance criteria can be sent to the client device.

In some embodiments, the client device 410 receives a hardware identifier from the peripheral device 412 upon the detection of the connection. In some embodiments, the hardware identifier includes a vendor identifier and a device identifier.

In some embodiments, the client device 410 is configured to send an alert to the device management server 430 following the detection of the connection of the peripheral device 412. In some embodiments, the acceptance criteria are updated based on the alert.

In some embodiments, the coupling of the peripheral device 412 includes installing, on the client device 410, a driver of the peripheral device 412. In some embodiments, the driver integrity is verified with a checksum.

In some embodiments, the usage data includes information about processes running on the client device prior to the coupling of the peripheral device, during the coupling of the peripheral device, or both.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A method for coupling a peripheral device to a client device, the method comprising:
computing, at a server, usage data for peripheral devices coupled to a fleet of client devices;
adding peripheral devices from the peripheral devices coupled to the fleet whose usage data meets a threshold to a whitelist;
detecting an attempt to connect a new peripheral device to an individual client device;
determining acceptability of the new peripheral device based on its presence on the whitelist, and
in response to the determining:
coupling the new peripheral device on the individual client device if the new peripheral is on the whitelist; or
preventing the coupling of the new peripheral device on the individual client device if the new peripheral device is not on the whitelist.

2. The method of claim 1, wherein the preventing and installing of coupling for the new peripheral device comprises detecting processes being executed on the individual client drive during the attempted connection of the new peripheral device.

3. The method of claim 2, wherein the detecting further comprises identifying one or more processes executed based on instructions provided by the new peripheral device.

4. The method of claim 1, wherein the new peripheral device is an input device, an output device, or an input/output device.

5. The method of claim 1, wherein the new peripheral device is a removable memory storage device.

6. The method of claim 1, wherein the attempt to connect the new peripheral device is via a wireless or a wired interface.

7. The method of claim 6, wherein the wired interface is universal serial bus (USB), high-definition multimedia interface (HDMI), display port (DP), peripheral component interconnect express (PCIe), serial AT attachment (SATA).

8. A method for operating a low trust user device environment comprising:
detecting a connection of a peripheral device to a client device;
determining acceptability of the peripheral device based on acceptance criteria from a device management server, and
in response to the determining:
coupling the peripheral device to the client device; or
preventing the coupling of the peripheral device to the client device.

9. The method of claim 8, wherein the acceptance criteria comprise a whitelist.

10. The method of claim 8, wherein the detecting comprises receiving a hardware identifier from the peripheral.

11. The method of claim 10, wherein the hardware identifier comprises a vendor identifier and a device identifier.

12. The method of claim 8, further comprising sending an alert to the device management server of the connection of the peripheral.

13. The method of claim 12, wherein the device management server updates the acceptance criteria based on the alert.

14. The method of claim 8, wherein the device management server updates the acceptance criteria based on usage data received from a fleet of user devices, the usage data including information about peripheral devices connected to the fleet.

15. The method of claim 8, wherein the determining comprises verifying the integrity of a driver for the peripheral device prior to coupling.

16. The method of claim 15, wherein the verifying the integrity comprises comparing checksum of the driver.

17. The method of claim 8, wherein the determining is based on local acceptance criteria and wherein the method further comprises:
receiving the acceptance criteria from the device management server and
updating the local acceptance criteria based on the received acceptance criteria from the device management server.

18. The method of claim 17, wherein the device management server is configured to send updates of the acceptance criteria to a fleet of client devices.

19. The method of claim 8, further comprising monitoring of processes executed on the user device prior to the coupling of the peripheral device, during the coupling of the peripheral device, or both.

20. A system for operating a low trust computing environment comprising:
a peripheral device;
a client device, the client device configured to:
detect a connection of the peripheral device to the client device;
determining acceptability of the peripheral based on acceptance criteria; and
in response to the determination:
couple the peripheral device to the client device; or
prevent the coupling of the peripheral device to the client device; and
a device management server configured to provide the acceptance criteria to the client device.

21. The system of claim 20, further comprising a fleet of client devices configured to send usage data to the device management server, the usage data including information on peripheral devices connected the fleet.

22. The system of claim 21, wherein the device management server updates the acceptance criteria based on the usage data received from a fleet of client devices.

23. The system of claim 21, wherein the client device receives a hardware identifier from the peripheral device upon the detection of the connection.

24. The system of claim 23, wherein the hardware identifier comprises a vendor identifier and a device identifier.

25. The system of claim 20, wherein the client device sends an alert to the device management server of the connection of the peripheral.

26. The system of claim 25, wherein the device management server is configured to update the acceptance criteria based on the alert.

27. The system of claim 20, wherein the coupling comprises installing, on the client device, a driver for the peripheral device.

28. The system of claim 27, wherein the installing comprises verifying the integrity of the driver prior to installation.

29. The system of claim 20, wherein the determining is based on local acceptance criteria and wherein the method further comprises receiving the acceptance criteria from the device management server and updating the local acceptance criteria based on the received acceptance criteria from the device management server.

30. The system of claim 21, wherein the usage data includes information processes running on the client device prior to the installing of the peripheral device, during the installing of the peripheral device, or both.
